(19) United States
(12) Patent Application Publication
(10) Pub. No.: US 2016/0323005 A1
(43) Pub. Date: Nov. 3, 2016

(54) MOBILE DEVICE CASE WITH INDEPENDENTLY OPERABLE CAMERA

(71) Applicant: Wayne Michael Cauthen, Chicago, IL (US)

(72) Inventor: Wayne Cauthen, Chicago, IL (US)

(73) Assignee: Wayne Michael Cauthen, Chicago, IL (US)

(21) Appl. No.: 15/139,200

(22) Filed: Apr. 26, 2016

Related U.S. Application Data
(60) Provisional application No. 62/179,097, filed on Apr. 29, 2015.

(51) Int. Cl. H04B 1/3888; H04N 5/232; H04N 5/225; H04W 4/00

(52) U.S. Cl. CPC H04B 1/3888; H04W 4/008; H04N 5/23293; H04N 5/2256

(57) ABSTRACT

The present invention includes a cover for a mobile device that includes a camera and internal memory storage. The invention allows users to quickly take photos or video without unlocking their phone or when the phone is turned off.

This Invention claims benefit under 35 U.S.C. §119(e) of United States provisional application Ser. No. 62/179,097, tiled on Apr. 29, 2015.

### BACKGROUND OF THE INVENTION

Mobile devices, such as smartphones, equipped with built-in cameras are increasingly ubiquitous. Because of this, virtually everyone now has the ability to take a photograph at almost any moment. Furthermore, such mobile devices are often accompanied by protective cases.

However, taking a picture with a mobile device often requires a time-consuming series of steps. For example, before taking a picture a user may need to “wake up” the device by pressing a button, “unlock” the device by swiping a touchscreen, enter a passcode and open the camera application. By the time these, or similar, steps have been completed, the moment that the user wished to photograph may have passed. Therefore, it would be advantageous to provide a user with a camera, which is ready to use comparatively quickly, for example at the push of a button, but does not require a user to carry an additional device.

### SUMMARY OF THE INVENTION

Some embodiments of the invention provide a user with a quick to use camera by embedding an independent camera in a mobile device's case. Since the camera is independent of the mobile device, the user need not waste time navigating the mobile device's interface but may simply “point and shoot.” Furthermore, since the invention is part of a mobile device's case, the camera should be available to the user whenever the user is carrying the mobile device.

Some embodiments of the invention may, like a normal mobile device case, be substantially rectangular with the exact dimensions depending on the particular mobile device for winch it is made. It generally comprises a device side, a camera side with a camera, four edges, a power source, means for storing data, and means for activating the camera. Some embodiments contains their own power source, data storage means, and camera, independent from a mobile device.

In certain embodiments, the invention has means of securing the mobile device to the case such that the mobile device's screen is exposed, which in the exemplary embodiment below takes the form of a recessed region meant to accommodate placement of the device, and the camera side is positioned opposite the device side such that the camera points away from the device. The case may be built to fit and accommodate a wide variety of mobile, cellular, and tablet devices.

To operate certain embodiments of the invention, the user would, upon seeing an object the user would like to photograph, orient the invention such that the camera is pointed toward the object. The user would then use the means of activating the camera to cause the camera to take a photograph. The photograph would then be stored on the means for storing data for future retrieval by the user.

The case may contain space for a memory storage means, such as a micro SD card, to which all recorded data can be saved and stored. The storage means may use a wireless communication protocol, such as Bluetooth to transfer its contents to a mobile device being held inside the case. Alternatively, the storage means may be communicably-coupled to a device, preferably through a micro USB or Lightning® connection. In some embodiments, a user c I use their mobile device to interact with the storage means via a graphical user interface (GUI). When the storage means is full memory, and can no longer make space to save recordings, it may no longer record any new data until space has been made available on the storage means or until a new card with available space has been properly associated with the invention. In some embodiments, when the storage means is full, a small light installed in the case will blink until the invention is associated with a. storage means with available storage. Preferably, this light is an LED.

The invention will also feature space for an energy storage means. Such energy storage may a durable, long-lasting coin cell battery that powers the case and its components. In some embodiments, the invention only draws from the battery when the case's camera is in use or there is need for power to interact with the memory storage.

In certain embodiments, the invention's camera may be accessed, and interacted with, independently from the mobile device. In these instances, the camera acts as a “point-and-shoot” camera with no viewfinder. These embodiments may not draw power from the device. However, other embodiments may draw power from the mobile device and/or the invention's independent energy storage means. In these embodiments, the invention's camera may interact with the mobile device, and the mobile device may act as a viewfinder.

### BRIEF DESCRIPTION OF THE DRAWINGS

FIG. 1 shows an elevational view of the camera-side of one embodiment in accordance with the present invention.

FIG. 2 shows an elevational view of the device-side of one embodiment in accordance with the present invention.

FIGS. 3A-3D show elevational views of the of one embodiment in accordance with the present invention.

FIGS. 4A-4F-show, in accordance with the present invention, the placement of the buttons in some embodiments and how a hand may interact with those embodiments.

### DETAILED DESCRIPTION

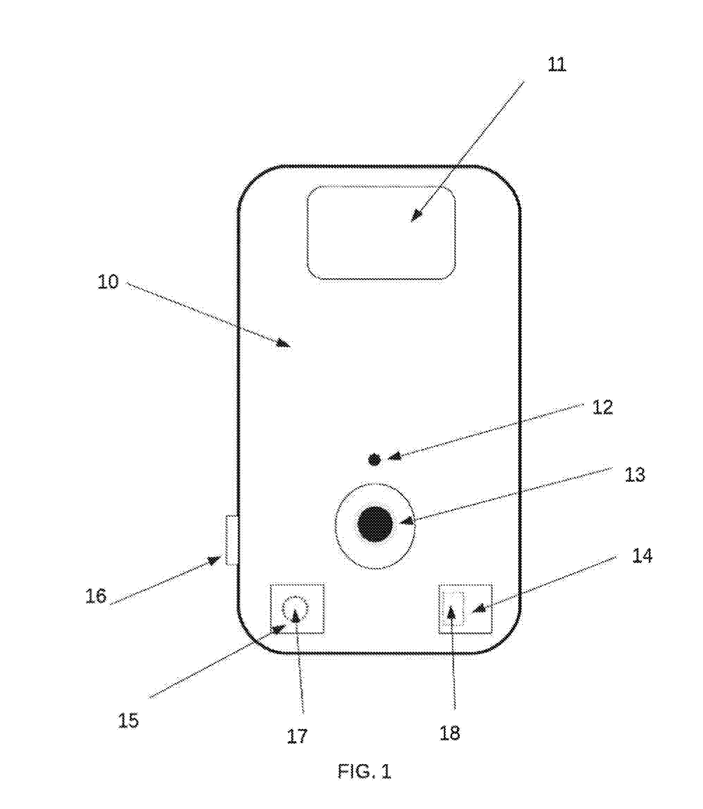

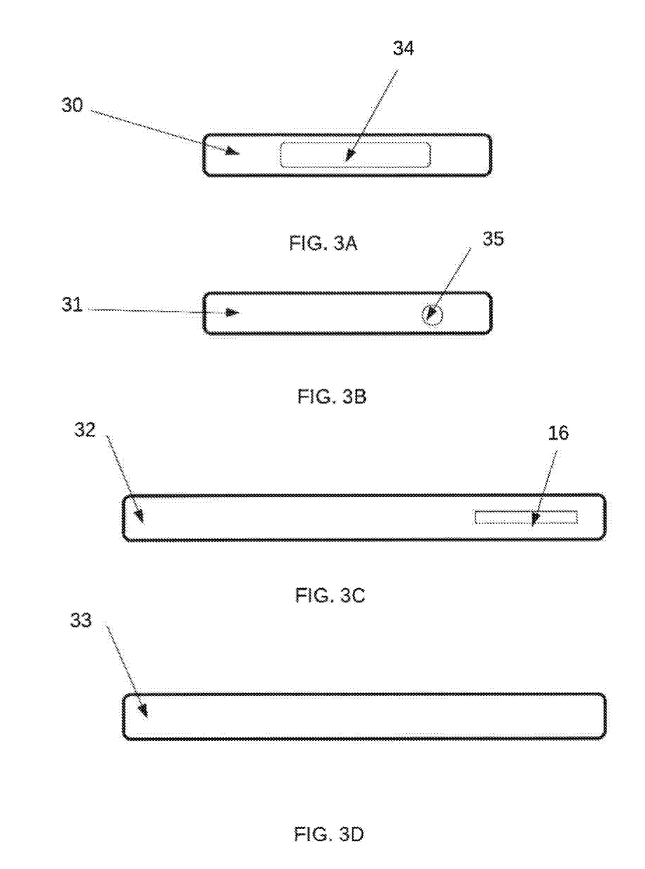

Regarding FIG. 1, the invention has at least a camera-side face 10 with a camera 13 disposed thereon. The invention also has a power source 17 and a means for storing data 18, situated in their respective compartments 15 and 14. While this particular embodiment depicts the power source as a coin cell type battery and the means for storing data as a microSD card, alternative implementations are contemplated. Also pictured is the means for activating the camera 16 which is shown here as a button protruding from one of the invention's edges (see FIG. 3C), but may actually be located in a number of other suitable locations in alternative embodiments.

This embodiment of the invention has a cut-out 11 to accommodate, for example, the mobile devices built in camera or speakers. Other embodiments may have more or fewer such cutouts, as needed. The pictured embodiment also includes an indicator light 12, such as an LED, which may be configured to, for example, inform the user of a low battery level or full memory.

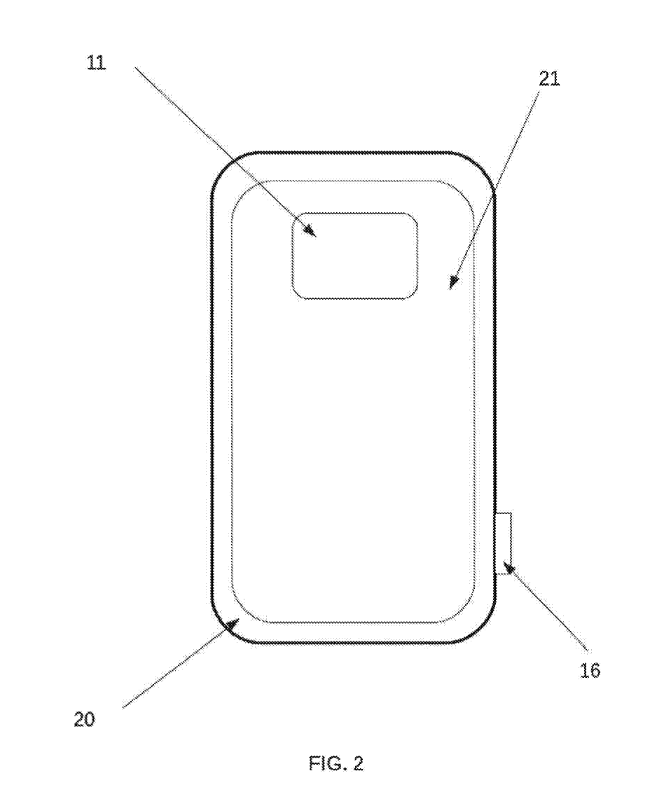

Regarding FIG. 2, the invention has at least a device side 20 with a recessed region 21 meant to accommodate placement of the device. The cutout 11 and means for activating the camera 16 can in this particular embodiment, also be seen from this side.

FIG. 3A shows a first short edge 30. The first short edge has a plug cut-out 34 to accommodate external connection to the device via, for example, USB. In other embodiments, the plug cut-out may be located elsewhere or omitted entirely depending on the particular mobile device to be accommodated.

FIG. 3B shows a second short edge 31 which is located opposite the first short edge. The second short edge has a headphone jack cut-out to accommodate connection to the mobile device via, for example, a 3.5 mm audio plug.

FIG. 3C shows a first long edge 32, including the means for activating the camera 16.

FIG. 3D shows a second long edge 33. In this particular embodiment, the second long edge contains no additional elements, but alternative embodiments with additional elements are contemplated.

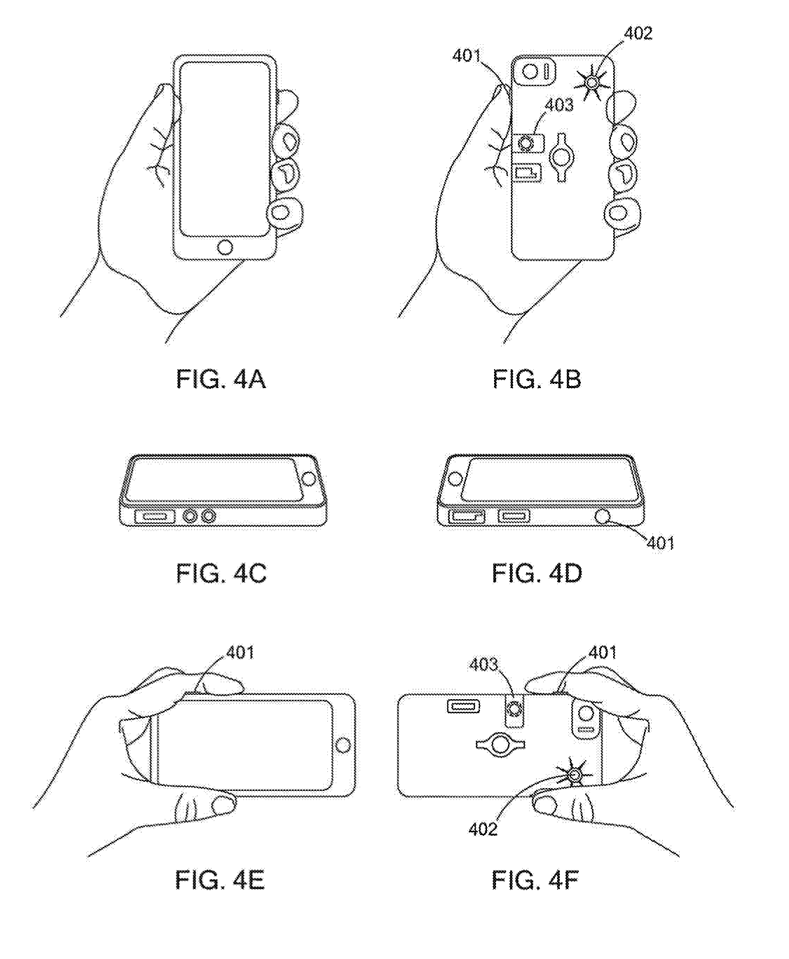

FIGS. 4A-F shows various elevations of the device as well as how user's hand may interact with the device. The shutter button 401 may be pressed while held in a number of angles. Additionally, the case's flash 402 and camera 403 are preferably positioned in ergonomic ways such that a hand may comfortably hold the device while not obstructing the flash 402 or camera 403.

What is claimed:

1. A system comprising:
a. A case for a mobile device;
b. a power source;
c. a camera; and
d. memory storage.

2. The system of claim 1 further comprising a means for the mobile device to communicate with the memory storage.

3. The system of claim 1 further comprising a means for the mobile device to communicate with the camera.

4. The system of claim 2 herein the camera is 1) powered by the power source and 2) operable to store images in the memory storage.

3. The system of claim 3 wherein the camera is functional when the mobile device is off.

6. The system of claim 3 wherein the cameras is functional when the mobile device is locked.

7. The system of claim 3 wherein the cameras is functional when the mobile device is inoperative

8. The system of claim 4 wherein the case is operable to draw power from either its own power source or the mobile device's power source.

9. The system of claim 1 further comprising a means for notifying a user that the memory storage is full.

10. The system, of claim 1 wherein the case may communicate with a mobile device.

11. The system of claim 10 wherein the case is operable to receive instructions from the mobile device.

12. The system of claim 11 wherein the user may use the mobile device to interact with the storage.

13. The system of claim 10 that is operable to use the mobile device as a viewfinder for the camera.

14. A method for recording an event comprising:
a. a case for a mobile device comprising: a power source, a camera, and memory storage;
b. wherein the camera is operable to capture video and/or images.

15. The method of claim 14 wherein the camera is operable if the mobile device is turned off.

16. The method of claim 14 wherein the camera is operable if the mobile device is locked.

17. The method of claim 14 wherein the camera is operable if the mobile device is inoperative

18. The method of claim 14 wherein the case may communicate with the mobile device.

19. A system comprising:
a. a case for a mobile device;
b. a power source;
c. a camera; and
d. memory storage;
e. wherein the case is operable to communicate with the mobile device; and
f. the camera or memory storage may draw power from either the power source or the mobile device.

20. The system of claim 19 wherein the camera is operable if the mobile device is turned off, locked, or otherwise inoperative.
